(19) United States
(12) Patent Application Publication
(10) Pub. No.: US 2026/0310834 A1
(43) Pub. Date: Oct. 8, 2026

(54) TAMPER DETECTION

(71) Applicant: NCIPHER SECURITY LIMITED, Cambridge (GB)

(72) Inventor: Jonathan Paul CROWE, Cambridge (GB)

(21) Appl. No.: 19/469,251

(22) PCT Filed: Mar. 27, 2024
(86) PCT No.: PCT/GB2024/050833

§ 371 Date: Sep. 25, 2025

(30) Foreign Application Priority Data
Mar. 31, 2023 (EP) 23275053.9

(51) Int. Cl. G06F 21/88

(52) U.S. Cl. CPC G06F 21/88

(57) ABSTRACT

A device includes an electrically conductive element and a processing module. The processing module is configured to: transmit a signal through the electrically conductive element; obtain, at a first time, a first measurement of the integrity of the signal transmitted through the electrically conductive element; obtain, at a second time, a second measurement of the integrity of the signal transmitted through the electrically conductive element; and responsive to detection of a change in the integrity of the signal between the first and second measurements, register a tamper event.

### FIELD

The present invention relates to methods for detecting a tamper event and devices configured to detect a tamper event.

### BACKGROUND

Various devices may be designed to store and perform operations with sensitive data. For example, a Hardware Security Module (HSM) is a device that securely stores and manages cryptographic keys, and performs a set of cryptographic operations, such as generating a cryptographic key, performing encryption and decryption, or performing digital signature and verification operations. Such devices may comprise mechanisms that protect against a malicious third party tampering with the device. For example, various features of the device may provide tamper detection.

Tamper detection may be implemented using some form of conductive labyrinth, for example a wire mesh or serpentine tracking, with some form of basic conductivity testing being used to detect a breach. For example, the labyrinth may be monitored to detect an open circuit. The labyrinth is provided around components of the device that store or perform operations with sensitive data Attempts to physically access the components to read the sensitive data may result in a break in the labyrinth, which is then detected as an open circuit.

However, attackers may attempt to defeat such methods by “linking out” sections of the labyrinth without detection. This may involve adding an additional conductive path in parallel with the section of the labyrinth, meaning that a break in the section of the labyrinth is no longer detectable from the conductivity testing. If successful, this leaves an unprotected hole in the tamper detection, and potentially leaves sensitive data vulnerable to attack.

### SUMMARY

According to a first aspect, there is provided a device comprising:
an electrically conductive element;
a processing module, configured to:
   transmit a signal through the electrically conductive element;
   obtain, at a first time, a first measurement of the integrity of the signal transmitted through the electrically conductive element;
   obtain, at a second time, a second measurement of the integrity of the signal transmitted through the electrically conductive element; and
   responsive to detection of a change in the integrity of the signal between the first and second measurements, register a tamper event.

The device performs tamper detection based on the detection of a change in the integrity of a signal, and in particular of a high speed signal. A “high speed signal” as described herein is a signal having a fast rise time and/or a high symbol rate. For example, the signal may have a symbol rate of 1 GHz or higher. The symbol rate is also referred to here as the “frequency” of the signal.

Signal integrity comprises a set of measures of the quality of an electrical signal. Issues impacting signal integrity include reflections, ringing, crosstalk, distortion and signal loss for example. A system may be able to support a certain amount of signal integrity loss, beyond which the signal may not be reliably recoverable.

The integrity of a high speed signal transmitted through an electrically conductive pathway (e.g. comprising one or more PCB traces) is highly sensitive to various phenomena that may have little to no impact on the integrity of a low speed signal Such phenomena can include loss, reflections, ringing, crosstalk, etc. For example, impedance discontinuities in the pathway can cause reflections, and lead to a loss of signal integrity. Designers of high speed circuits (e.g. PCBs intended to operate at high speeds) can take these effects into account, e.g. by controlling the characteristic impedance of a conductive trace such that the integrity of a high speed signal is maintained along the length of the trace.

The device described herein monitors for a tampering event by monitoring for a change in signal integrity along a tamper detection pathway.

In an example, an electrically conductive element, such as a PCB trace, carries a high speed signal in a regime in which a first loss of signal integrity occurs, but in which the signal is still recoverable. In such a regime, any change in integrity (for example a further loss) is very pronounced. The device is therefore highly sensitive to modifications. Modifications to the electrically conductive element would generally cause a change in the impedance for example. By monitoring the integrity of the high speed signal for a change (e.g. a further loss) in the integrity of the signal (e.g. caused by a change to the impedance), possible tampering events such as touch, scraping, compression, heating, modifications to the signal or the electrically conductive element itself, and even vibrations, may be detectable. Tampering events occurring in the surroundings of the electrically conductive element may also be detectable, for example on areas of a PCB on which the element is disposed. Such tamper detection methods may therefore be more difficult to defeat than methods that test for an open circuit, for example.

In some examples, tamper detection comprises detecting a change in an amount of signal loss when the high speed signal is transmitted through the electrically conductive element. In some examples, tamper detection comprises detecting a change in an amount of signal jitter when the high speed signal is transmitted through the electrically conductive element. A change of signal integrity may comprise a change of signal loss and/or a changed amount of signal jitter. A loss of signal integrity may comprise an increased signal loss and/or an increased amount of signal jitter.

One way of measuring the integrity of a signal is to measure one or more eye pattern parameters. For example, detecting a change in the integrity of the signal may comprise detecting a change in an eye height and/or an eye width.

In some examples, the signal comprises a first level and a second level. In some examples, obtaining the first measurement of the integrity of the signal comprises obtaining a first plurality of samples of transitions between the first level and second level, and obtaining the second measurement of the integrity of the signal comprises obtaining a second plurality of samples of transitions between the first level and second level. Such samples can be used to determine one or more eye pattern parameters.

For example, the first time may be a time at the end of a first period, where the first measurement of the integrity of the signal may be an eye height and eye width determined from the first plurality of samples, which are obtained in the first period. The second time may be a time at the end of a second period, wherein the second period comprises a period of time after the first period. The second period may start at the end of the first period and comprise a period of time immediately after the first period. The second period may start some time after the first period. The second period may contain part or all of the first period. The second measurement of the integrity of the signal may be an eye height and eye width determined from the second plurality of samples, which are obtained in the second period, and which include a plurality of samples obtained after the first period.

The eye pattern parameters may be repeatedly and continually monitored, and a change in the parameter values can be detected.

The first and second levels may correspond to different voltages. The first level may be a high level and the second level may be a low level. The first level may correspond to a bit value of “one” and the second level may correspond to a bit value of “zero”.

In the case of a digital signal, an eye pattern comprises an image showing the distributions of the “zero” and “one” levels of the signal, and the “crossing points” of the signal, when many samples of transitions between “one” and ‘zero’ in the signal are superimposed. Changes in signal integrity result in changes to the eye pattern, and in particular in narrowing or widening of the position of these levels and/or crossing points, corresponding to an increase or decrease in the eye height and/or eye width (in other words an “opening” or “closing” of the eye).

It is noted that the term “eye pattern” is used herein to refer to the image itself, and the term “eye pattern image data” is used herein to refer to the pixel data used to display the image. The term “eye pattern data” is used herein to refer to the sampled values that could be used to generate eye pattern image data. The term “eye pattern parameter” is used herein to refer to one or more properties, including the eye height and the eye width. The values of these parameters can be determined directly from the eye pattern data, or the eye pattern data can be used to generate eye pattern image data, and the values of these parameters can be determined from the eye pattern image data. It will be appreciated that determining one or more eye pattern parameters does not necessarily mean producing an eye pattern that can be viewed or visualised, e.g. on an oscilloscope. For example, determining eye pattern data may comprise measuring data that, if provided to an oscilloscope, would enable the oscilloscope to display an eye pattern, and detecting a change in the integrity of the signal may comprise detecting a change in one or more eye pattern parameters that, if the eye pattern were visualised on the oscilloscope, would be seen as a change in the height and/or width of the eye.

The tamper detection method may, in some examples, comprise obtaining a plurality of samples of the high speed signal, determining distributions of the zero and one levels and/or the crossing points, and detecting a change in those distributions. An energy loss in the signal is detected as a reduction in the eye height A reduction in the eye width results from increased jitter due to impedance changes and inter-symbol interference, for example. It will be appreciated that the eye height and eye width may exhibit a certain amount of variation without any tampering taking place. An additional amount of variation, for example an amount over a pre-determined threshold, may be attributable to tampering.

Obtaining the first measurement of the integrity of the signal may comprise: obtaining a first plurality of sample values for a first plurality of samples of the signal at a particular point on the signal waveform, and determining a first distribution of sample values from the first plurality of sample values. Obtaining the second measurement of the integrity of the signal may comprise: obtaining a second plurality of sample values from a second plurality of samples of the signal at the particular point on the signal waveform, and determining a second distribution of sample values from the second plurality of sample values. Detecting a change in the integrity of the signal may comprise detecting a change in the distribution of sample values between the first distribution of sample values and the second distribution of sample values. For example, the particular point on the signal waveform could be on a crest or a trough or on a rising or falling edge of the signal. The values could correspond to an amplitude (e.g. a voltage or current) and/or a time.

Obtaining the first measurement of the integrity of the signal may comprise: obtaining a first plurality of samples of first levels and second levels, and determining a first distribution of sampled first levels and a first distribution of sampled second levels from the first plurality of samples. Obtaining the second measurement of the integrity of the signal may comprise: obtaining a second plurality of samples of first levels and second levels, and determining a second distribution of sampled first levels and a second distribution of sampled second levels from the second plurality of samples. Detecting a change in the integrity of the signal may comprise detecting a change in the distribution of sampled levels between the first and second distributions of sampled first levels and/or between the first and second distributions of sampled second levels. It will be appreciated that the first and/or second level(s) may exhibit a certain amount of variation without any tampering taking place, for example due to the characteristic impedance of the electrically conductive element. Any additional amount of variation may be attributable to tampering. A change in the distribution(s) of first and/or second level(s) may correspond to a change in variation between samples. For example, an increased variation in the first and/or second level(s) may indicate an additional loss of energy.

Obtaining the first measurement of the integrity of the signal may comprise determining a first edge of the first plurality of samples of transitions between the first level and second level, and obtaining the second measurement of the integrity of the signal may comprise determining a second edge of the second plurality of samples of transitions between the first level and second level. The first and second edges may correspond to edges of distributions of sampled first and second levels, respectively. The first and second edges may correspond to edges of distributions of the crossing points. In some examples, edges of distributions of the sampled first and second levels, as well as distributions of the crossing points, may be determined in the first and second measurements.

It will be appreciated that the waveform may exhibit a certain amount of variation without any tampering taking place. An additional amount of variation, for example an amount over a pre-determined threshold, may be attributable to tampering.

In some examples, the frequency of the signal is selected as giving a first reduction in integrity of the signal following transmission through the electrically conductive element. Detecting a change in the integrity of the signal may then comprise detecting a further reduction in integrity of the signal or detecting an increase in the integrity of the signal. In some examples, transmitting the signal comprises generating a signal with a frequency corresponding to a first integrity of the signal transmitted through the electrically conductive element, wherein the first integrity is less than or equal to 0.75 times a maximum integrity of a signal transmitted through the electrically conductive element. In some examples, transmitting the signal comprises generating a signal with a frequency corresponding to a first eye height of the signal transmitted through the electrically conductive element, wherein the first integrity is less than or equal to 0.75 times a maximum eye height of a signal transmitted through the electrically conductive element. In some examples, transmitting the signal comprises generating a signal with a frequency corresponding to a first eye width of the signal transmitted through the electrically conductive element, wherein the first integrity is less than or equal to 0.75 times a maximum eye width or a signal transmitted through the electrically conductive element.

The frequency selection may be based on: the material composition of the electrically conductive element; the capabilities of a transmitter configured to transmit the signal; the capabilities of a receiver configured to receive the signal and/or measure the integrity of the signal; and/or the length of the electrically conductive element. It will be appreciated that integrity loss of a high speed signal following transmission by the electrically conductive element may be greater for a greater length of electrically conductive element. The frequency of the signal is selected to be sufficiently high that transmission of the signal through the electrically conductive element causes a reduction in signal integrity from a maximum integrity.

In some examples, transmitting the signal comprises generating a signal with a frequency corresponding to a first loss of the signal transmitted through the electrically conductive element, wherein the first loss is greater than or equal to 25%. A loss of at least 25% allows an improvement in the loss, for example as a result of the electrically conductive element being shortened, to be reliably detected. In some examples, the first loss is at least 30%, at least 40%, at least 50%, at least 60%, at least 70%, at least 80%, at least 90%, at least 96%, or at least about 99% of the energy of the signal. The maximum loss that may be used depends on the transmitter and receiver characteristics. For example, an internal automatic gain control may be used.

Detecting the change in integrity of the signal may comprise detecting a further loss of energy of the signal or detecting an increase in the energy of the signal.

In some examples, detecting a change in the integrity of the signal comprises detecting an increase or decrease in signal jitter. Signal jitter is a measure of the timing variation of the signal. An increase in signal jitter may correspond to a reduction in an eye width. An increase in signal jitter may indicate tampering. For example, signal jitter may be induced by incident radiation. There may exist a threshold amount of signal jitter.

Detected amounts of jitter that are at or below the threshold amount may indicate normal transmission of the signal in the regime in which the signal and the electrically conductive element are configured to cause some loss of signal integrity. Detecting an increase in signal jitter may comprise detecting an amount of signal jitter that is above the threshold amount.

In some examples, transmitting the signal through the electrically conductive element comprises generating a signal comprising a first data sequence, and wherein the processing module is further configured to compare, at the second time, the signal transmitted through the electrically conductive element to the first data sequence; and responsive to detecting a difference in the sequence of data, register a tamper event.

The signal may be a digital signal. The signal may comprise a pseudorandom binary sequence.

The electrically conductive element may comprise any suitable conductor, for example a cable or wire (e.g. flying wire). In some examples, the electrically conductive element comprises a conductive trace disposed on a printed circuit board. In some examples, the electrically conductive element is a first electrically conductive element and the device further comprises a second electrically conductive element, wherein the first electrically conductive element and the second electrically conductive element form a differential pair.

Registering a tamper event may comprise, for example, outputting information indicating a tamper event, for example an alert. Registering a tamper event may further comprise outputting information about the tamper event, such as date and time, details of the detected change in integrity, etc. The method may comprise, for example, storing the information about the tamper event in a database. Registering a tamper event may comprise erasing sensitive data from the device.

In some examples, the signal is a first signal and wherein the first signal is transmitted for a first time period to obtain the first measurement and wherein the first signal is transmitted for a second time period after the first time period to obtain the second measurement, wherein the processing module is further configured to:
transmit a second signal through the electrically conductive element, the second signal having a different frequency to the first signal;
obtain, at a third time, a third measurement of the integrity of the signal transmitted through the electrically conductive element;
obtain. at a fourth time, a fourth measurement of the integrity of the signal transmitted through the electrically conductive element, wherein the second signal is transmitted for a first further time period to obtain the third measurement and wherein the second signal is transmitted for a second further time period after the first further time period to obtain the fourth measurement, wherein the first further time period is after the first time period and before the second time period, and the second further time period is after the second time period; and
responsive to detection of a change in the integrity of the signal between the third and fourth measurements, register a tamper event.

For example, the method may comprise transmitting signals of different frequencies through the electrically conductive element in turn. Each frequency may be selected as giving a reduction in integrity of each signal following transmission through the electrically conductive element. Using a plurality of signals having different frequencies may enhance the sensitivity of the tamper detection. For example, a spectrum of integrity measurements at different frequencies can be obtained, and any change in the spectrum, for example a change in the integrity at one or more frequencies, caused by tampering can be detected.

In some examples, the frequencies of the signal(s) (e.g. of the first signal and/or the second signal) may be randomised, and/or randomly selected. Randomising (e.g. randomly varying) the frequencies of the signals in this way may enable detection of a tampering attack in which an attacker attempts to avoid detection by replacing the signal with a test signal having a non-randomised frequency.

In some examples, the change in integrity may be detected as a change in an error rate. For example, an error rate may be monitored. A tamper event may be registered when the error rate exceeds a pre-determined threshold error rate. It may be the case that there is a range of error rates below the pre-determined threshold corresponding to normal transmission of the signal.

In some examples, a tamper event may be registered when the error rate is outside of a pre-determined range (e.g. above an upper threshold error rate or below a lower threshold error rate). For example, a signal that has a lower than expected error rate may also be indicative of a tamper event.

In some examples, different signals having different frequencies may correspond to different pre-determined threshold error rates.

In some examples, the electrically conductive element is provided on or in a first region of a printed circuit board and the device further comprises a first component configured to store or process sensitive data, wherein the first component is mounted on the printed circuit board within the first region. In some examples, the electrically conductive element is provided on or in a first region of a printed circuit board and the device further comprises a first component configured to store or process sensitive data, wherein a connection to the first component is provided on or in the printed circuit board within the first region. The electrically conductive element may comprise a PCB trace. The electrically conductive element may be arranged around components and/or connections that are configured to carry, store and/or process sensitive data. The electrically conductive element may form a labyrinthine conductive path.

In some examples, a measurement of the integrity of the signal may be performed using a time domain reflectometry measurement. For example, transmitting the signal through the electrically conductive element may comprise transmitting a first signal edge at the first time, and obtaining the first measurement of the integrity may comprise performing a first time domain reflectometry measurement Transmitting the signal further comprises transmitting a second signal edge at the second time, and obtaining the second measurement of the integrity comprises performing a second time domain reflectometry measurement. Detecting a difference between the first measurement and the second measurement may indicate a tamper event.

In some examples, a measurement of the integrity of the signal may be performed using a measurement of scattering parameters. For example, transmitting the signal through the electrically conductive element may comprise transmitting a first signal at the first time, and obtaining the first measurement of the integrity may comprise measuring a first set of S-parameters. Transmitting the signal further comprises transmitting a second signal at the second time, and obtaining the second measurement of the integrity comprises measuring a second set of S-parameters.

Detecting a difference between the first measurement and the second measurement may indicate a tamper event.

According to another aspect, there is provided a method comprising:
transmitting a signal through an electrically conductive element;
obtaining, at a first time, a first measurement of the integrity of the signal transmitted through the electrically conductive element;
obtaining, at a second time, a second measurement of the integrity of the signal transmitted through the electrically conductive element; and
responsive to detection of a change in the integrity of the signal between the first and second measurements, registering a tamper event.

According to another aspect, there is provided a device comprising:
an electrically conductive element.
a processing module, configured to:
   transmit a signal through the electrically conductive element;
   obtain a time domain reflectometry measurement for the signal; and
   responsive to detection of a reflection, register a tamper event.

According to another aspect, there is provided a method comprising:
transmitting a signal through an electrically conductive element;
obtaining a time domain reflectometry measurement for the signal; and
responsive to detection of a reflection, registering a tamper event.

### BRIEF DESCRIPTION OF THE DRAWINGS

Devices and methods in accordance with non-limiting embodiments will now be described with reference to the accompanying figures in which:

FIG. 1(a) schematically illustrates a device according to an example;

FIG. 1(b) is a schematic illustration of an example System on a Chip (SoC) field-programmable gate array FPGA which may be provided in a device according to an example;

FIG. 1(c) is a schematic illustration of an example first voltage signal;

FIG. 1(d) is a schematic illustration of an example second voltage signal;

FIG. 2(a) schematically illustrates the signal loss for the first electrically conductive element with no tampering;

FIG. 2(b) schematically illustrates the attenuation of a signal for a longer electrically conductive element with a dashed line;

FIG. 3 shows a schematic illustration of an eye diagram;

FIG. 4(a) shows an example eye pattern;

FIG. 4(b) shows an example eye pattern;

FIG. 4(c) shows an example eye pattern;

FIG. 4(d) shows an example eye pattern;

FIG. 4(e) shows an example eye pattern;

FIG. 5 illustrates a method of tamper detection according to an example;

FIG. 8 illustrates another method of tamper detection according to an example;

FIG. 7 is a schematic illustration showing a plan view of an example HSM device.

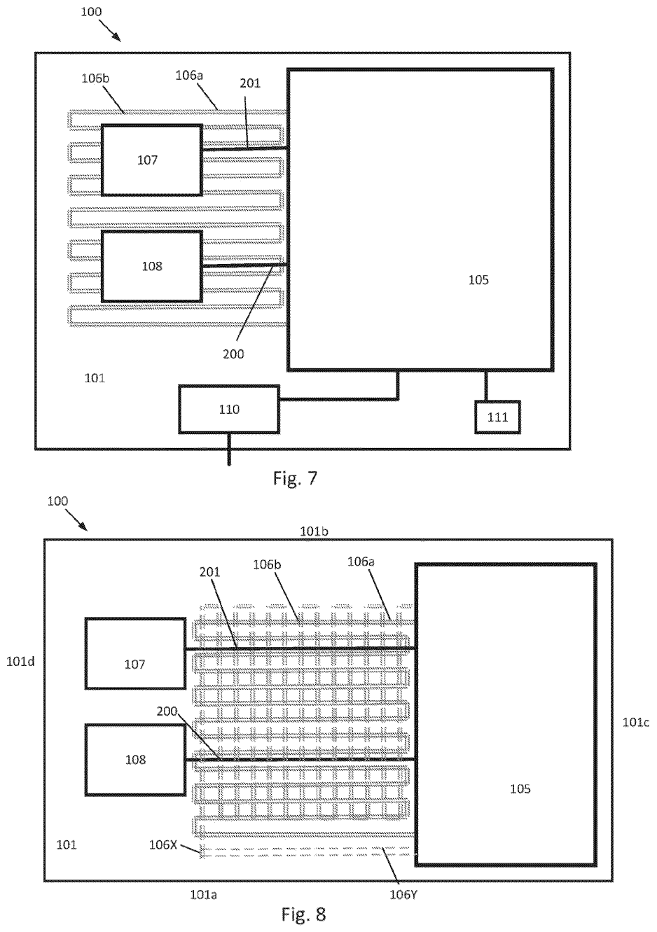

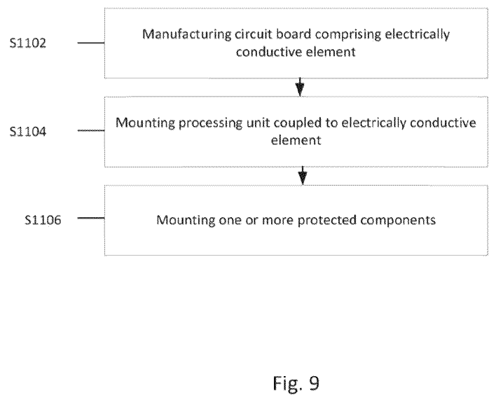

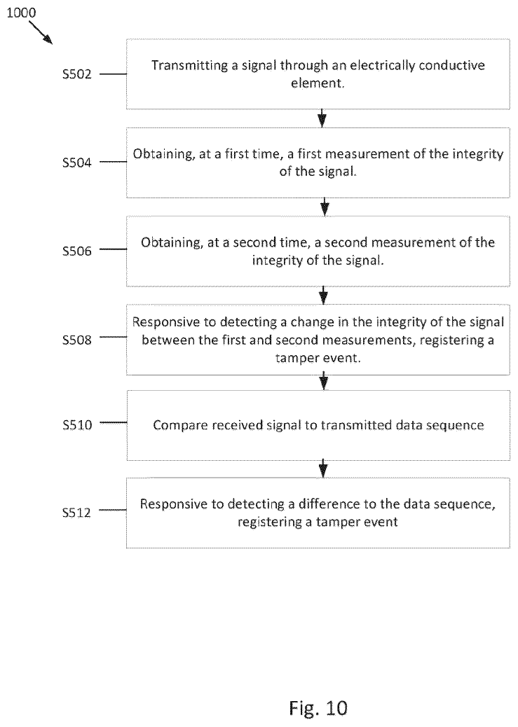

FIG. 8 is a schematic illustration showing a plan view of an example HSM device;

FIG. 9 is a flow chart of a method of manufacturing a device according to an example;

FIG. 10 illustrates another method of tamper detection according to an example.

### DETAILED DESCRIPTION

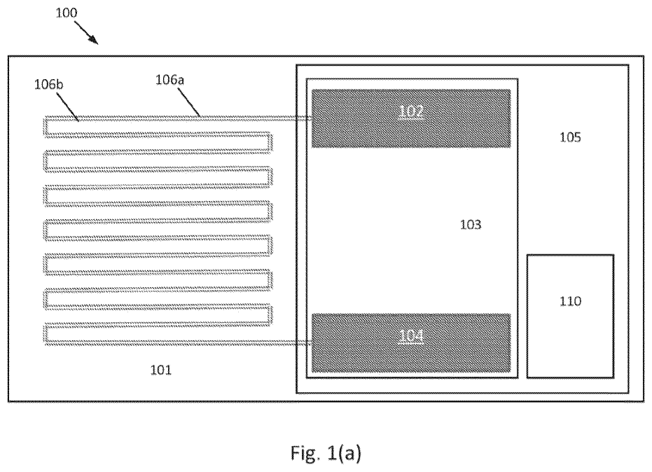

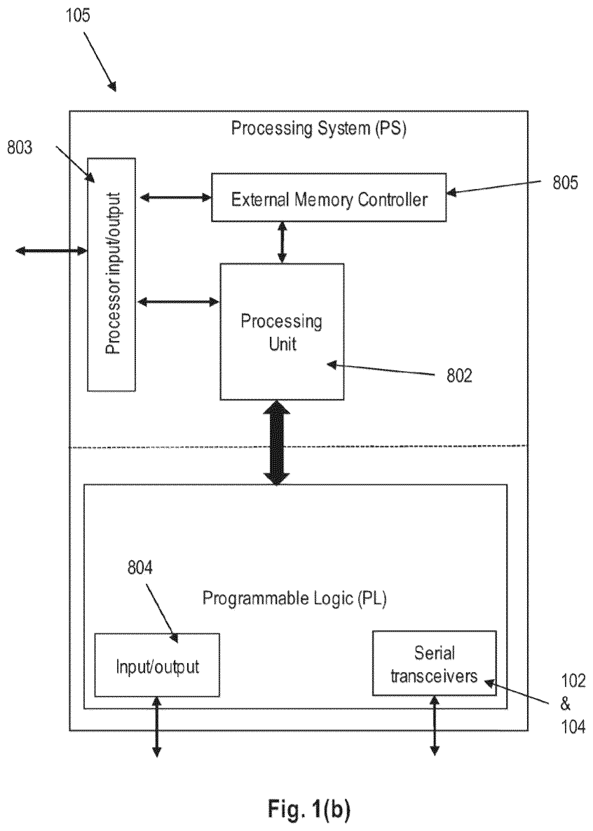

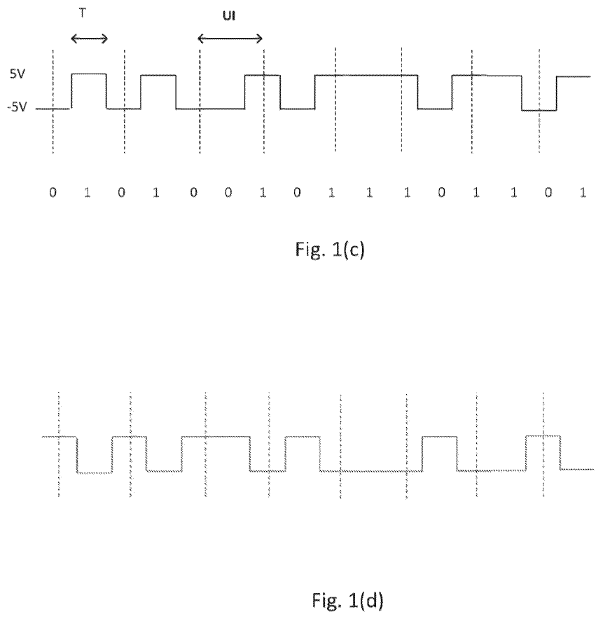

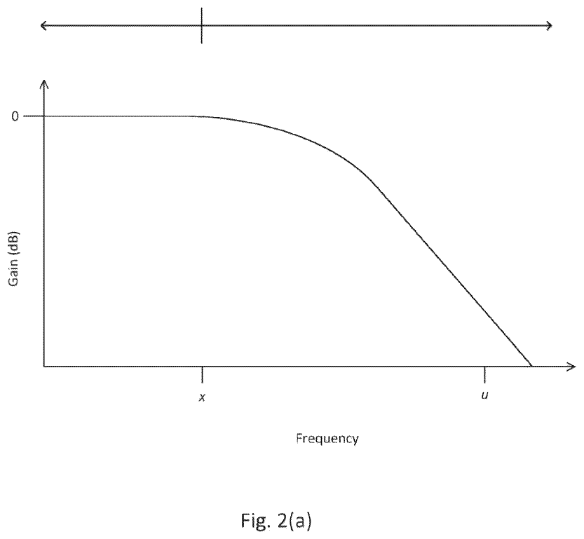

FIG. 1(a) schematically illustrates a device 100 according to an example.

The device 100 comprises a processing module 105, comprising a transmitter 102 and a receiver 104. The transmitter 102 is a high speed transmitter and the receiver 104 is a high speed receiver. In this example, the transmitter 102 and receiver 104 are combined in a transceiver element 103, however in other examples, the transmitter 102 and the receiver 104 may be provided as separate elements. In this example, the processing module 105 comprises a System on a Chip (SoC) field-programmable gate array FPGA. For example, the processing module 105 may be a Xilinx Zynq® UltraScale+™ System on a Chip (SoC) The transmitter 102 and the receiver 104 are implemented as a transceiver 103 in the programmable logic of the SoC FPGA, and in particular are implemented as a serial transceiver, in other words the transceiver 103 is configured to transmit data sequentially, one bit at a time. For example, the transmitter 102 and the receiver 104 may be implemented as a gigabit serial transceiver (GT). Although an example in which the processing module 105 comprises a System on a Chip (SoC) field-programmable gate array FPGA is described here, in other examples the processing module 105 may be a CPU or ASIC for example.

The processing module 105 further comprises a tamper detection module 110. The tamper detection module 110 in this example is implemented as software in the processing system of the SoC FPGA 105. In particular, software running in the processing system of the SoC FPGA 105 reads control/status registers in the transceiver 103. In alternative examples, the tamper detection module 110 may be implemented in the programmable logic. In some examples, the tamper detection module 110 is implemented by the receiver 104.

Further details of the processing module 105 according to this example are described in relation to FIG. 1(b) below.

The device 100 further comprises a printed circuit board (PCB) 101. The processing module 105 is mounted on the PCB 101.

The device 100 further comprises an electrically conductive element. In this example, the device comprises a first electrically conductive element 106a and a second electrically conductive element 106b. The first electrically conductive element 106a and the second electrically conductive element 106b are a pair of differential conductors. In one example, the first electrically conductive element 106a and the second electrically conductive element 106b may be at least 5 cm in length. In one example, the first electrically conductive element 106a and the second electrically conductive element 106b may be between 5 cm and 50 cm in length.

The first electrically conductive element 106a and the second electrically conductive element 106b are a microstrip differential pair. The first electrically conductive element 106a and the second electrically conductive element 106b are connected to the serial transceiver 103 in the programmable logic in the processing module 105. In particular, the first electrically conductive element 106a in this example is a single element connected at one end to the transmitter 102 and at the other end to the receiver 104.

The second electrically conductive element 106b in this example is also a single element connected at one end to the transmitter 102 and at the other end to the receiver 104. The first path from the transmitter 102 to the receiver 104, comprising the first electrically conductive element 106a, has a continuous impedance. The second path from the transmitter 102 to the receiver 104, comprising the second electrically conductive element 106b, also has a continuous impedance.

The transmitter 102 is configured to transmit a signal through each of the first electrically conductive element 106a and the second electrically conductive element 106b to the receiver 104. The first electrically conductive element 106a in this example comprises a first trace formed on or in the PCB 101. The first trace is connected at one end to a first pin of the processing module 105 connected to the transmitter 103 and at the other end to a second pin of the processing module 105 connected to the receiver 104. For example, the first trace may be connected at each end to the relevant pins of the processing module 105 through a solder joint. The second electrically conductive element 106b in this example comprises a second trace formed on or in the PCB 101.

The second trace is connected at one end to a third pin of the processing module 105 connected to the transmitter 103 and at the other end to a fourth pin of the processing module 105 connected to the receiver 104. For example, the second trace may be connected at each end to the relevant pins of the processing module 105 through a solder joint. In other examples, the electrically conductive elements may comprise one or more wires or cables, for example a flying wire or high-speed cable.

The first electrically conductive element 106a is arranged so as to protect one or more other components or connections (not shown) on or in the PCB 101. In this example, the first electrically conductive element 106a is provided on the surface of the PCB 101 on which the one or more components are mounted. One or more connections to the one or more components are provided on an internal layer of the PCB 100. The electrically conductive element is provided at least partly over connections.

Alternatively, the electrically conductive element may be provided at least partly around each of the one or more components. Alternatively, the first electrically conductive element 106a is provided on an internal surface of a layer of a multiple layer PCB 101, in a serpentine pattern across an area of the PCB 101. The one or more components to be protected may be mounted on a face of the PCB 101 within this area, so that the one or more components are mounted on a part of the PCB 101 within which the first electrically conductive element 106a is provided. In these cases, the first electrically conductive element 106a is arranged on or in the PCB 101 such that a potential attacker would face difficulty in physically accessing the one or more components, and/or the one or more connections to the one or more components, without some disturbance to the first electrically conductive element 106a.

The second electrically conductive element 106b is provided alongside the first electrically conductive element 106b, with a small gap provided between them, such that the second electrically conductive element 106b is arranged in the same manner as the first electrically conductive element 106. The second electrically conductive element 10b is the same length as and follows the same path as the first electrically conductive element 106a, just slightly spaced apart.

Thus in this example, the serial connection to the SoC FPGA comprises of a pair of differential conductors arranged in a serpentine pattern on or in the PCB 101. The PCB 101 layout is constructed to provide good signal integrity. In particular, the PCB layout 101 is constructed to provide continuous impedance.

The transmitter 102 provides a first voltage signal through the first electrically conductive trace 106a and a second voltage signal through the second electrically conductive trace 106b, where the second signal corresponds to the inverted first signal. In other words, the second voltage signal is equal in magnitude but of opposite polarity to the first voltage signal. The receiver 104 measures the difference between the two signals. In this manner, noise can be cancelled in the final measured signal. In this example, a differential signal is used. Other implementations (not using a differential signal) are possible, such as using a single-ended conductive trace on a PCB, surrounded by grounds, with a single-ended signal. Other implementations may use a single co-axial cable to transport a single-ended signal for example.

FIG. 1(c) is a schematic illustration of an example first voltage signal and FIG. 1(d) is a schematic illustration of an example second voltage signal. The first voltage signal is a digital signal comprising a sequence of bits. In particular, the first voltage signal is a serial signal. The amplitude of the first voltage signal changes between a minimum value (for example −5V) and maximum value (in this example +5V), with the maximum value corresponding to a bit value of 1 and the minimum value corresponding to a bit value of 0. These are also referred to as the high and low values. The minimum value is also referred to as a second level and the maximum value as a first level.

In an ideal signal, the transition between the minimum value and maximum value is instantaneous, however, in practice a signal is generated with a fast rise time. For example, a rise time of less than 1 ns may be generated. In some examples, the rise time is as short as around 10 ps.

The symbol duration time T is the period of time for which the signal remains at the maximum or minimum value to indicate one symbol, and is shown in the figure. The symbol rate is 1/T, and is the number of symbol changes, or signalling events per unit of time. The symbol rate is also referred to herein as the frequency of the signal or the signal rate. In this example, the maximum value indicates a bit value of 1 and the minimum value indicates a bit value of 0, with 1 bit per symbol. Thus in this example, the bit rate is the same as the symbol rate, and the bit period is the same as the symbol period. However, the bit rate may be twice the symbol rate for example. For example, PAM4 encoded signals can be used to obtain twice as many bits.

The first voltage signal has a high frequency. For example, the first voltage signal may have a frequency of greater than or equal to 1 GHz. The first voltage signal may have a frequency of greater than or equal to 10 GHz. The first voltage signal may have a frequency of greater than or equal to 10 GHz and less than or equal to 15 GHz. In this example, the first voltage signal is generated as a pseudorandom binary sequence.

However, in other examples the first voltage signal is generated with a different bit pattern, for example an alternating sequence of bits, or some selected bit sequence. As described above, the second voltage signal is the inverse of the first voltage signal, and therefore has the same frequency as the first voltage signal.

The signal transmitted through the first electrically conductive element 106a and the signal transmitted through the second electrically conductive element 106b may exhibit a change in integrity in response to a tamper event. Tampering may comprise touching either electrically conductive element (for example in an attempt to reach the one or more protected components), and/or attempting to modify either electrically conductive element (for example by linking out a section of the electrically conductive element) for example. Signal integrity comprises a set of measures of the quality of an electrical signal. One measure of signal quality is signal loss.

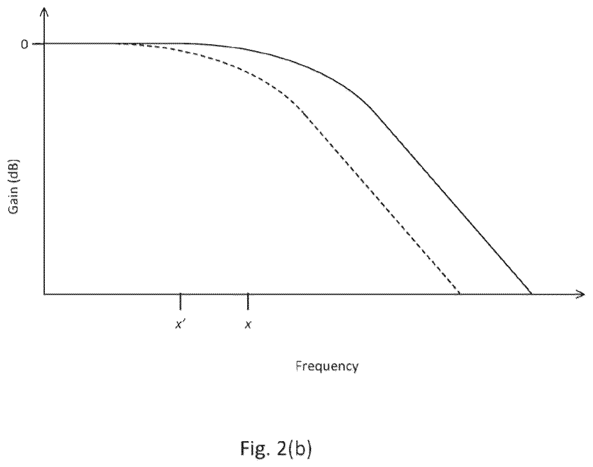

FIG. 2(a) schematically illustrates the signal loss for the first electrically conductive element 106a and second electrically conductive element 106b with no tampering and no impedance discontinuities. The y axis shows a gain of the signal in dB. A gain below zero is referred to as a loss, or attenuation, of the signal. The gain may be an amplitude gain (voltage gain), for example, given by:

$$20 log \frac{{A}_{o}}{{A}_{i}}$$

where A₀ is the voltage value corresponding to a “one” level for the received signal and A₁ is the voltage value corresponding to a “one” level for the transmitted signal. It will be appreciated that similar relationships would be observed for other types of signal loss, e.g. signal power loss or signal energy loss.

The x axis shows the frequency on a log scale. The figure illustrates the relationship between the energy lost from a differential signal during transmission by the first electrically conductive element 106a and second electrically conductive element 106b, against the signal frequency.

As shown in FIG. 2(a), a signal may experience little to no loss (~0 dB) for signals having a frequency below a threshold frequency x. This is referred to as the low-doss' regime. However, for signals with frequency higher than the threshold frequency x, the signal loses energy during transmission. This is referred to as the “frequency-related losses” regime. Above the threshold frequency x, losses occur due to material effects. FIG. 2(a) shows the loss for a signal transmitted through a trace with no impedance discontinuities. Introduction of impedance discontinuities into the signal path will introduce noise into the loss measurement.

The value of x depends on the properties of the transmitting medium—i.e. the material of the first electrically conductive element 106a and second electrically conductive element 106b, and the length of the first electrically conductive element 106a and second electrically conductive element 106b. For example, if the first electrically conductive element 106a and second electrically conductive element 106b are made longer, the value of x would decrease. This is illustrated in FIG. 2(b), which illustrates the attenuation of a signal for a longer electrically conductive element with a dashed line. The threshold frequency moves from x to x′ as the length is increased.

Furthermore, similar losses may be observed varying with signal rise time. A signal loss corresponds to a loss of signal integrity (i.e. the recoverability of the signal following transmission).

In order to maximise signal recovery, high speed PCB design involves selecting the length and material of the trace for a desired signal frequency to reduce attenuation of the signal. In other words, a PCB is designed and the frequency selected so that the transmission occurs in the low-loss regime, in which there is a low signal loss. In contrast, the device 100 of FIG. 1(a) deliberately uses a signal in the frequency-related losses regime to detect tampering. For example, a tampering event which changes the properties of the first electrically conductive element 106a and the second electrically conductive element 106b (for example linking out a section) would be expected to cause a change in signal loss (e.g. by causing a change in length).

The signal sent along the first electrically conductive element 106a and the signal sent along the second electrically conductive element 106b in the device 100 of FIG. 1(a) operate in the frequency-related losses regime, i.e. at frequencies greater than or equal to x. In particular, they operate in a regime in which the signal already experiences a non-zero signal loss (i.e. some loss of integrity) in the absence of a tampering event, but in which the signal is still recoverable. Given the properties of the electrically conductive elements, a frequency is selected that is greater than or equal to x and less than or equal to u. The value of u is selected so that the differential signal is still recoverable in the absence of a tampering event. In this regime, the differential signal is highly sensitive to any events that have a further impact on its integrity. For example, if an attacker attempts to link out a section of the electrically conductive elements, this changes the length of the electrically conductive elements. In the low-loss regime, this would have only a minor impact on the signal loss. However, as can be seen in FIG. 2(b), in the frequency-related losses regime, a small change in length can result in a large change in signal loss.

It is envisaged that tampering by an attacker would likely result in a further loss of signal integrity, although it is also possible that a tampering event could cause a modification of the transmissive path that would result in an improved signal loss, for example by reducing the length of the transmissive path while matching the impedance of the original path. In such cases, reduction in signal loss would be detected. By choosing the operating point to be where the signal is already losing energy, both worsening signals and improving signals (e.g. due to the PCB lines being shortened) can be detected.

Preferably, the signal operates in a regime in which at least about a quarter of the signal energy is lost before a tampering event is detected. In some examples, to maximise the sensitivity to tampering events, the signal operates in a regime in which around 99% or more of the signal energy is lost before a tampering event is detected. It will be appreciated that the device should operate in a regime in which the signal has enough energy that a change in signal energy can be detected.

The frequency of the signal required to reach this regime depends on the length of the electrically conductive element 106, the capabilities of the transmitter 102 and/or the receiver 106, and/or the material of the first electrically conductive element 106a and second electrically conductive element 106b. Usually, the choice of material for the first electrically conductive element 106a and second electrically conductive element 106b has the largest impact on the whether or not this regime is reached for a given signal frequency. For example, for a PCB trace comprising FR4, the regime may be reached at a signal frequency of ~1 GHz. In another example, for a PCB trace comprising Astra MT77, the regime may be reached at a signal frequency of ~10 GHz.

The frequency selection may also take into account the capabilities of the transceiver and the length of the transmission path. Making the path longer may protect more of the PCB area.

For example, a frequency may be selected to obtain an amplitude (voltage) loss of around −3 dB For a 10 inch PCB trace comprising FR4, a −3 dB loss is seen at 3 GHz. For a 10 inch trace of Megtron 6, a −3 dB loss is seen at around 15 GHz. In some examples, a device 100 may be configured, through selection of electrically conductive element material and frequency, to operate in a regime resulting in a signal energy loss of 0 dB to −40 dB. In a further example, a device 100 is configured to operate in a regime resulting in a signal energy loss of −20 dB to −30 dB, e.g. about −20 dB In some examples, a device 100 may be configured, through selection of electrically conductive element material and frequency, to operate in a regime resulting in a signal energy loss of 0 dB to −10 dB. In a further example, a device 100 is configured to operate in a regime resulting in a signal energy loss of about −5 dB.

The above description focused on signal loss, which is one measure of signal integrity. However, other factors contribute to signal integrity, including reflections and crosstalk for example.

The device is designed to avoid impedance discontinuities in the first electrically conductive element 106a and second electrically conductive element 106b. By reducing impedance discontinuities, at frequencies above x, the signal gain decreases monotonically with increasing frequency, as illustrated in FIGS. 2(a) and 2(b). The introduction of impedance discontinuities results in noise in the signal loss, potentially obscuring any change in the signal loss caused by a tamper event.

One or more parameters of an eye pattern are another measurement of signal integrity that reflect the impact of other factors such as reflections and crosstalk, as well as signal loss.

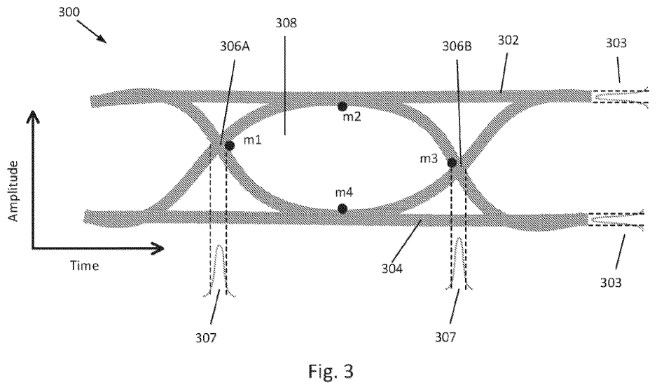

A schematic illustration of an eye pattern 300 that may be generated from a signal measured at the receiver 104 when the first voltage signal and second voltage signal are provided by the transmitter 102 for a first period is shown in FIG. 3. An eye pattern can be generated by sampling the received signal multiple times. The position of each sample within a time period referred to as a unit interval is then determined. Various methods of determining the position of a sample within the unit interval may be used. In one simple example, a fixed rate method may be used, in which the unit interval is simply set based on the symbol period. For example, the unit interval may be set as twice the symbol period, and the received signal essentially sliced into sections, each of which is one unit interval long. The first unit interval may be triggered half a symbol period after a detected rising edge. This method is illustrated in FIG. 1(c), in which the unit interval (UI) is indicated by the dashed lines. The time point of each sample within the UI is then determined. To plot an eye pattern, the samples for each unit interval are all plotted on a single plot, with the x-axis being the time point within the unit interval, and the y axis being the sampled voltage value. The density of the samples at each point may also be represented in the eye pattern, for example by colour or intensity. Other methods for determining the position of a sample within the unit interval may be used—for example, the unit interval boundaries may be determined with reference to a clock signal.

Some unit intervals will correspond to a transition having consecutive bits with the same value. In particular, the top “rail” of the eye pattern corresponds to samples from unit intervals with a 1-1-1 transition and the bottom rail corresponds to samples from unit intervals with a 0-0-0 transition. The peak shape in the eye diagram corresponds to a 0-1-0 transition, and the trough shape corresponds to a 1-0-1 transition. The first (leftmost) rising edge corresponds to the 0-1-1 transition and the second (rightmost) rising edge corresponds to the 0-0-1 transition. The first (leftmost) falling edge corresponds to the 1-0-0 transition and the second (rightmost) falling edge corresponds to the 1-1-0 transition.

It is noted that the term “eye pattern” is used herein to refer to the image itself, and the term “eye pattern image data” is used herein to refer to the pixel data used to display the image. The term “eye pattern data” however is used herein to refer to the sampled values that could be used to generate eye pattern image data—in particular, the eye pattern data may comprise a plurality of data points, each data point comprising a voltage value and a time value, where the time value corresponds to a time point within the unit interval. Although various eye patterns are shown here for illustration, in this example, the receiver 104 calculates the eye pattern data directly from the received signal—in other words, the eye pattern image data is not generated. The term “eye pattern parameter” is used herein to refer to one or more properties, examples of which will be described below, including the eye height and the eye width. The values of these parameters can be determined directly from the eye pattern data, or the eye pattern data can be used to generate eye pattern image data, and the values of these parameters can be determined from the eye pattern image data. In this example, the receiver 104 calculates one or more eye pattern parameter values and provides these to the tamper detection module 110. In other examples, the receiver 104 calculates the eye pattern data from the received signal and provides this eye pattern data to the tamper detection module 110. The tamper detection module 110 then calculates one or more eye pattern parameter values from the received eye pattern data. In particular, it is to be understood that obtaining eye pattern parameter values does not necessitate displaying an eye pattern or generating eye pattern image data.

As mentioned, in this example, receiver 104 generates eye pattern data from the received signal. The receiver 104 repeatedly calculates one or more eye pattern parameter values from the eye pattern data and sends to the tamper detection module 110. The receiver 104 may calculate the one or more eye pattern parameter values once every second, or in response to one or more events (such as switch on or access to a particular component). The tamper detection module 110 compares the most recent one or more eye pattern parameter values to previous data, for example to one or more previous eye pattern parameter values or to some statistical combination of previous eye pattern parameter values (such as a mean value).

In this example, a pre-determined threshold amount of variation in each of the one or more eye pattern parameter values, above which a change in the distribution of sample values can be considered to be a likely tamper event, is used. For example, the receiver 104 may generate eye pattern data for a first time period. The first time period may be 1 second. The receiver 104 generates one or more eye pattern parameter values at a first time, where the first time is the end of the first period, and the parameter values are generated from the eye pattern data corresponding to the first period. The receiver 104 then generates eye pattern data for a second time period. The second time period may be the period of 1 second directly after the first time period.

The receiver 104 then generates one or more eye pattern parameter values at a second time, where the second time is the end of the second period, and the parameter values are generated from the eye pattern data corresponding to the second period. The one or more eye pattern parameter values generated at the first time and at the second time are then sent to the detection module 110, which compares the values and determines if the difference in one or more of the one or more values exceeds a respective pre-determined threshold.

In other examples, the second period may start some time after the first period, or the second period may contain part or all of the first period.

As illustrated in FIG. 3, the eye pattern 300 shows the distributions of first 302 and second 304 levels of a signal (also referred to as “high” and “low” levels, respectively, or “one” and “zero” levels, respectively, in the case of a digital signal) across the multiple unit intervals, where different unit intervals may correspond to different transitions. The “cross-over regions” 306A, 3068B are the locations where the transitions between the two levels occur—in other words where the rising and falling edges cross—also sometimes referred to as the x-crossings or the zero-crossings. The “eye” 308 of the eye pattern 300 is the empty area between the high and low levels and the crossings.

It will be appreciated that the widths of each of the distributions depend on the amount of variation between samples over the total period of time over which the eye pattern 300 is formed—in this case the first period (comprising multiple unit intervals). The distributions of the signal levels 303 and of the crossing points 307 are shown illustratively in FIG. 3. It will be appreciated that a width of a distribution 303, 307 may be defined as being a difference between two edges of a distribution. The edges of a distribution (shown, for example, as dashed lines in FIG. 3) may be defined in any suitable way. For example, the edges of a distribution may be defined as the further most points.

The eye 308 may be defined by 4 points on the eye pattern, identified in FIG. 3 as m1, m2, m3, and m4. The points m1, m2, m3, m4 may be used to define eye pattern parameter values. In some examples, an eye pattern parameter value is calculated as the voltage value corresponding to the point m2 minus the voltage value corresponding to the point m4 In some examples, an eye pattern parameter value is calculated as the time value corresponding to the point m3 minus the time value corresponding to the point m1.

The location of points on the eye pattern may be determined by firstly selecting a point corresponding to a location in the eye 308 (e.g. a centre of the eye 308) and sampling a value (e.g. density) at that point, and subsequently moving (i.e. scanning) the selected point horizontally along the time axis while monitoring the sampled value for a change. When a change in the sampled value (e.g. a change in sampled density) is detected, this may indicate the location of an edge of a distribution. For example, the selected point may be moved in a direction corresponding to decreasing time on the time axis, and a change in the sampled value may indicate the edge of the crossing point 306A. Likewise, the selected point may be moved in a direction corresponding to increasing time on the time axis, and a change in the sampled value may indicate the edge of the crossing point 306B. Similarly, the selected point (e.g. at the centre of the eye 308) may be moved vertically along the amplitude axis to locate the edges of the first 302 and second 304 levels, respectively. In one example, the eye pattern parameter values are calculated by determining the difference between a lower edge of the first level 302 and an upper edge of the second level 304, and the difference between the inner edges of the crossing points 306A, 306B.

In the example of FIG. 3, the eye pattern parameter values calculated by the tamper detection module 110 comprise the eye height and the eye width.

A tamper attempt is likely to cause a change in the eye height or in the eye width. For example, as has been described previously, a tamper attempt such as linking out a section of the first electrically conductive element 106a in order to access a protected component causes an increase in length of the transmission path of the first voltage signal. This in turn causes an increase in signal loss. This results in a reduction in the eye height. A tamper attempt causing an impedance discontinuity (for example, touching the electrically conductive element 106a with a probe) may cause reflections, resulting in inter-symbol interference. e.g. one bit interfering with adjacent bits due to reflections. This results in an increase in signal jitter, which results in a reduction in the eye width.

Other eye pattern parameter values may be calculated. For example, a change in signal integrity can cause a change in one or more of the distribution widths. For example, a reduction in signal integrity may cause an increase in a width of one or more distributions 307 at the “cross-over regions” 306A, 306B. Therefore, monitoring the widths of the distributions 307 for variation over time can enable detection of a change in signal integrity, and therefore of a tamper event. The widths of the distributions 307 are example eye pattern parameters. Various locations on the eye may be monitored.

As mentioned, the processing module 105 may be a Xilinx Zynq® UltraScale+™ System on a Chip (SoC). Parameters such as eye height and eye width may be determined using an RX Margin Analysis tool for example, which is implemented in the Xilinx Zynq® UltraScale+™ System on a Chip (SoC). Alternatively, other tools or analysis may be performed in software on the SoC to extract parameters. For example, the points m1, m2, m3, m4 may be determined by sampling the signal waveform at different horizontal and vertical offsets using the RX clock data recovery (CDR) function. These values are then provided to the tamper detection module 110 as described above.

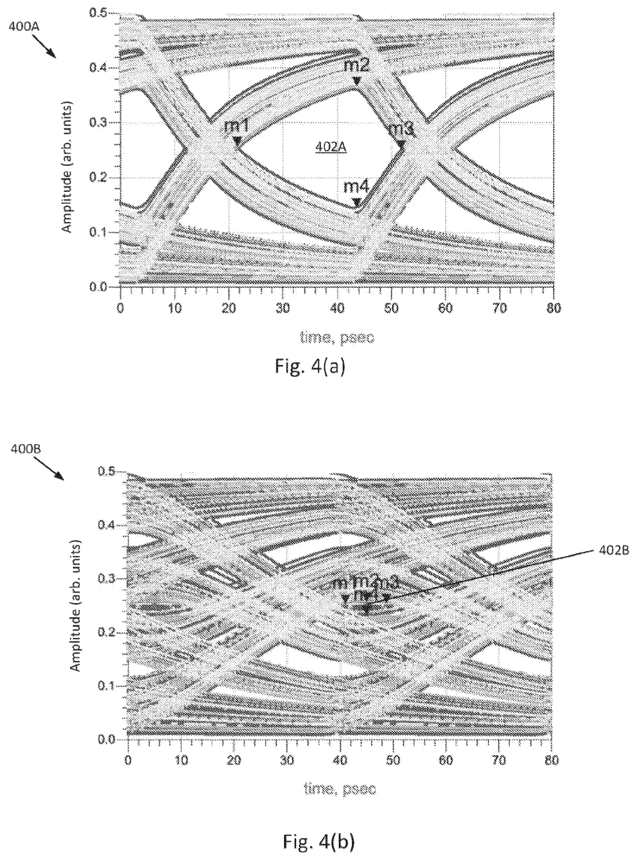

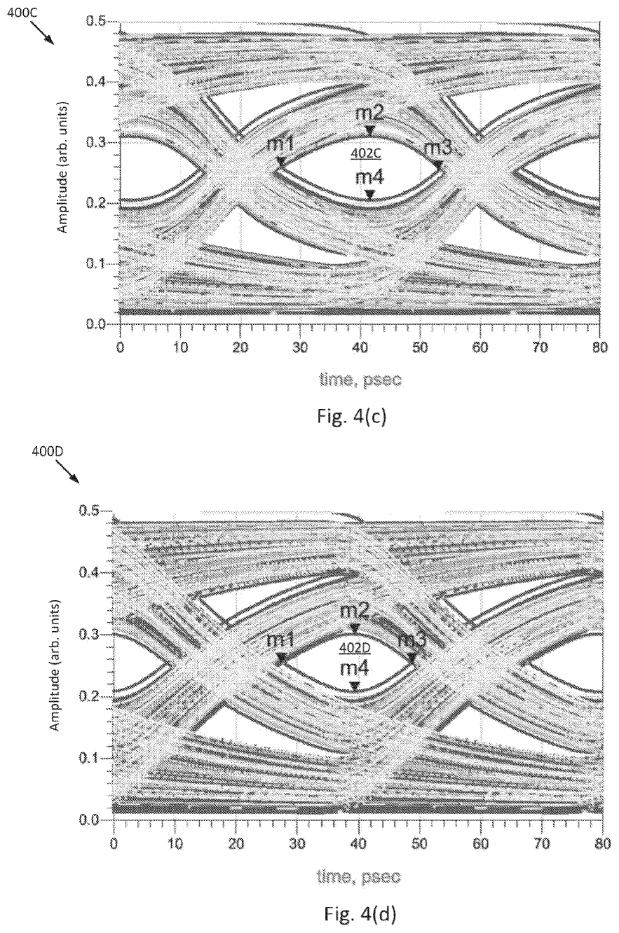

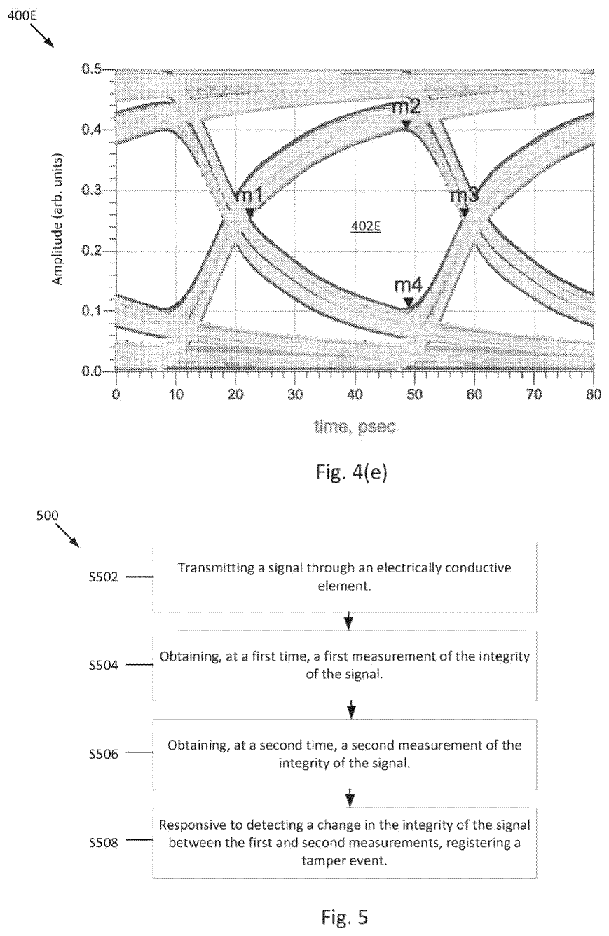

FIGS. 4(a) to 4(e) illustrate examples of eye patterns for a simulation of a 25 Gbps signal transmitted through 30 cm ideal PCB traces. The time axis unit interval is two bits.

The eye pattern 400A in FIG. 4(a) corresponds to a simulation of the 25 GHz signal transmitted through a 30 cm trace without a tamper event. The trace design and the signal bitrate are chosen to cause a reduced eye height and/or width (i.e. a partial loss of signal energy or integrity) even when not in a tampered state. This results in an eye 402 that is approximately 40% ‘open’. It will be appreciated that imperfections in a real PCB trace may mean that a real device would run at a lower frequency in order for the signal to be recoverable (i.e. for the eye not to collapse completely), while still being in a regime in which significant energy/integrity losses occur. For example, a signal frequency of ~1 GHz, ~5 GHz, ~10 GHz, or ~15 GHz could be used. For example a frequency in the range of 1-10 GHz may be used for a PCB trace comprising FR4. A frequency in the range of 10-15 GHz may be used for materials such as MT77. In one example, the frequency of the signal is selected so that the eye height and eye width are around 50% of the values for an ‘open’ eye (i.e. obtained at low frequency and under normal conditions) to provide anti-tamper sensitivity. Any modification to the trace then causes a significant change to one or more eye pattern parameters—in most cases to the measured eye height rather than width.

FIG. 4(b) illustrates an eye pattern 4008 for the same simulated signal and trace as in FIG. 4(a), with a touch from a human finger modelled as a 1 pF capacitor. As can be clearly seen in FIG. 4(b), the eye 4028 completely collapses as a result of this tamper event (i.e. touch), indicating a loss of signal integrity.

FIG. 4(c) illustrates an eye pattern 400C for the same simulated signal and trace as in FIG. 4(a), with an added impedance discontinuity (corresponding to a change in impedance of ~30%). Such a discontinuity could be introduced as part of a tamper event, such as an attempt to modify the trace. As a result of the impedance discontinuity, the eye 402C “closes” by approximately 50% relative to the eye 402A in FIG. 4(a).

Even if a modification to the trace is performed in which the impedance is perfectly matched, any change in the overall length of the trace is still clearly apparent from the eye pattern. FIG. 4(d) illustrates an eye pattern 400D for the same simulated signal and trace as in FIG. 4(a), but where the length of the trace has been extended by 10 cm. Again, the eye 402D is “closed” by approximately 50% relative to the eye 402A in FIG. 4(a). Similarly, FIG. 4(e) illustrates an eye pattern 400E for the same simulated signal and trace as in FIG. 4(a), but where the length of the trace has been reduced by 10 cm. In this case, the eye 402E is “opened” by approximately 50% relative to the eye 402A in FIG. 4(a) (corresponding to an increase in signal integrity).

As will be appreciated from the examples presented in FIGS. 4(a) to 4(e), an attacker would experience great difficulty in preventing detection by monitoring of changes to the eye pattern parameters. That is, in order to prevent a change in the eye pattern parameters (which are measures of signal integrity), any attempt at tampering comprising modifications to the trace may require at least require matching the impedance and the length of the trace.

It will be appreciated that the eye patterns illustrated in FIGS. 4(a) to 4(e) merely provide a visual representation of the effects of tamper events. As described previously, it is not necessary to produce or display an eye pattern for the purposes of integrity measurement or tamper detection. Rather, eye pattern parameters may be determined from eye pattern data that could be used to produce an eye pattern, and tamper detection performed by detecting changes in those parameters, without actually producing an eye pattern.

While the examples of eye patterns described and illustrated herein correspond to two level (e.g. two voltage level) signals for simplicity, it will be appreciated that the methods and devices described herein may be equally implemented using signals having any number of levels, e.g. 4 levels (such as a PAM4 signal).

In the device 100, the tamper detection signal operating frequency is selected to be where frequency-related losses have started, and a continuous impedance is provided for the tamper detection path, to provide the a good signal integrity. This allows any change in the tamper detection path to be easily detected in the signal integrity.

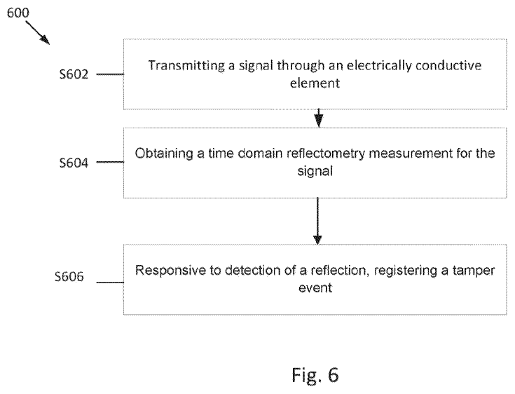

FIG. 5 illustrates a method 500 according to an example. The method 500 may be performed by the device 100 illustrated in FIG. 1(a). The method performs tamper detection based on detection of a change in integrity of a signal.

At step S502 of the method 500, a signal is transmitted through an electrically conductive element. For example, referring to the device 100 illustrated in FIG. 1, the first voltage signal is transmitted through the first electrically conductive element 106a and the second voltage signal is transmitted through the second electrically conductive element by transmitter 102.

At step S504 of the method 500, a first measurement of the integrity of the signal is obtained at a first time. For example, referring to the device 100 illustrated in FIG. 1(a), the first measurement of the integrity of the differential signal may be obtained by a receiver 104. The first measurement of the integrity of the signal comprises a first eye height value and a first eye width value.

At step S508 of the method 500, a second measurement of the integrity of the signal is obtained at a second time. For example, referring to the device 100 illustrated in FIG. 1, the second measurement of the integrity of the differential signal may be obtained by a receiver 104. The second measurement of the integrity of the signal comprises a second eye height value and a second eye width value.

Although in the above example, the measurement of the integrity of the signal comprises a measurement of eye height and eye width, other eye pattern parameters may additionally or alternatively be used, such as eye amplitude, edge rate, or total jitter. Other measurements of the integrity of the signal may additionally or alternatively be used, such as signal loss (e.g. voltage loss) for example.

At step S508 of the method 500, a tamper event is registered responsive to detecting a change in the integrity of the signal between the first and second measurements. A tamper event may be registered when a change is detected that is above or equal to a threshold amount, where any change below the threshold amount is considered to be within a normal operating tolerance.

Registering a tamper event may comprise alerting a user to the tamper event, for example triggering an alarm. Registering a tamper event may comprise outputting information about the tamper event (such as date and time, details about the detected change in integrity, etc.), for example to a database. Registering a tamper event may comprise outputting information to another device. Registering a tamper event may comprise providing a notification that a tamper event has taken place to another device. Registering a tamper event may comprise erasing sensitive data from the processing module 105 and/or one or more of the one or more protected components.

Erasing sensitive data may comprise, for example, erasing at least a part of a cryptographic key, for example a master key. For example, one or more of the protected components may store cryptographic material which is erased in response to detection of a tamper. The processing module 105 can detect the tamper and erase the stored cryptographic key material.

The signal may be continuously transmitted, and further measurements of signal integrity taken at pre-determined intervals, or in response to particular events (for example access to a particular component). The method may comprise continually monitoring the integrity of the signal for a change that may indicate a tamper event.

FIG. 10 illustrates another method 1000 according to an example. The method 1000 may be performed by the device 100 illustrated in FIG. 1(a). The method performs tamper detection based on detection of a change in integrity of a signal and detection of a change in the data sequence in the signal.

Steps S502 to S508 are performed as described previously. The transmitted signal in this example is a pseudorandom binary sequence, and a pseudo-random sequence of bits is transmitted. However, other data sequences may be used, for example a pre-determined pattern of bits, or a data sequence comprising more than 2 levels. In this example, the signal integrity measurement comprises determining one or more eye pattern parameter values. In particular, the eye height and eye width are determined.

In S510, the received data sequence is compared to the data sequence which was transmitted. In this step, the data sequence to be transmitted by the transmitter 102 (for example the pseudorandom binary sequence of bits) is compared against the data sequence received by the receiver 104. In this step, it is determined whether there is a difference between the data sequence to be transmitted and the received data sequence. In some examples, any change in the data sequence may be detected as a difference. For example, where any bit of the received data sequence is different, this is detected as a difference. For example, the signal to be transmitted comprises a sequence of bits 0101001011101101 as in FIG. 1(c). Where the received sequence comprises the sequence of bits 0101001001101101 (i.e. 1 bit is changed), this is detected as a difference. In other examples, an error rate is monitored, and if the error rate exceeds a pre-determined threshold, this is detected as a difference.

In S512, responsive to detecting a difference, a tamper event is registered. As explained above, registering a tamper event may comprise alerting a user to the tamper event, for example triggering an alarm. Registering a tamper event may comprise outputting information about the tamper event (such as date and time, details about the detected change in integrity, etc.), for example to a database. Registering a tamper event may comprise outputting information to another device. Registering a tamper event may comprise providing a notification that a tamper event has taken place to another device. Registering a tamper event may comprise erasing sensitive data from the processing module 105 and/or one or more of the one or more protected components. Erasing sensitive data may comprises, for example, erasing at least a part of a cryptographic key, for example a master key. For example, one or more of the protected components may store cryptographic material which is erased in response to detection of a tamper. The processing module 105 can detect the tamper and erase the stored cryptographic key material.

Steps S510 and S512 may be performed only if no change in the integrity of the signal is detected. In other examples, S510 and S512 may be performed prior to S504 to S508, and S504 to S508 are performed only if no change in the data sequence is detected. In other words, if either a change in the integrity or a change in the data sequence is detected, a tamper event is registered—it is not then necessary to perform the other check in some examples.

In this example, while operational the transmitter 104 is configured to transmit a continuous test pattern. The test pattern may be a repeating pattern or a pseudo random pattern for example. Patterns including several types of 0/1 transitions may be used to generate an eye diagram (for example one or more of: 000, 001, 010, 111, 100, 110, 101, 111). The detection module performs two functions:
1) Analyses the quality of the received signal using the eye pattern parameters. If the signal quality changes, that is an indication of a tamper. An alarm may be raised
2) Recovers the test pattern. If errors occur, a tamper is indicated. An alarm may be raised.

The detection module may be implemented by the receiver 104 for example.

As has been described above, at high frequencies, transmission of a signal becomes much more complicated than simple conductivity, as at these frequencies more fundamental effects are present. A high speed channel is created through the tamper detection labyrinth, so that an attempt to modify the labyrinth, for example connecting just one end of a wire in preparation for linking a section out, will cause a detectable change in integrity at the point the signal is received.

As the tamper detection mechanism is harder to defeat, it may not be necessary to use obfuscating methods, such as potting, to hide the serial connections in some devices.

In the above described examples, a single differential signal is used. However, in other examples, more than one differential signal may be transmitted through the electrically conductive elements, and monitored for a change in integrity. For example, a plurality of differential signals having different frequencies could be transmitted through the electrically conductive elements, and a tamper event could be registered if a change in integrity is detected for any of the signals in the plurality of signals. Multiple operating frequencies can be used (e.g. 10 GHz, 12.5 GHz, 16 GHz) to get a “spectrum” of signatures to enhance sensitivity. For example, the signals at different frequencies may be provided in cycles, where each signal is provided for 1 second to generate one or more eye pattern parameter values. The eye pattern parameter values for each frequency are compared to previous eye pattern parameter values for the respective frequency.

For example, a first signal is transmitted for a first time period to obtain a first integrity measurement. A second signal is transmitted for a further first time period immediately after the first time period to obtain a third integrity measurement. The second signal has a different frequency to the first signal. The first signal is then transmitted for a second time period immediately after the further first time period to obtain a second integrity measurement. The second signal is then transmitted for a further second time period immediately after the second time period to obtain a fourth integrity measurement. The first and second integrity measurements are compared, and the third and fourth integrity measurements are compared. A change in either case causes registration of a tamper event.

In this case, the method comprises transmitting signals of different frequencies through the electrically conductive element in turn. Each frequency may be selected as giving a reduction in integrity of each signal following transmission through the electrically conductive element as has been described above Using a plurality of signals having different frequencies may enhance the sensitivity of the tamper detection. For example, a spectrum of integrity measurements at different frequencies can be obtained, and any change in the spectrum (for example a change in the integrity at one or more frequencies) caused by tampering can be detected.

In the above described example, the processing module 105 comprises a System on a Chip (SoC) field-programmable gate array FPGA. FIG. 1(b) is a schematic illustration of an example System on a Chip (SoC) field-programmable gate array FPGA.

A Field Programmable Gate Array (FPGA) comprises an integrated circuit or part of an integrated circuit comprising an array of programmable logic blocks and a hierarchy of reconfigurable interconnects that allow blocks to be wired together in order to implement a user specified functionality. Unlike a Central Processing Unit, an FPGA can be configured after its manufacture. A manufacturing step defines the fixed logic that is present in the FPGA, including the programmable logic blocks, the presence of any specific Digital Signal Processing or Memory blocks etc. However, further functionality implemented by the FPGA is then defined at a later stage when the interconnections between the various blocks are formed.

FIG. 1(b) shows a schematic illustration of an example SOC (System-on-a-Chip) Field Programmable Gate Array (FPGA), which may be included in the device 100 as the processing module 105. A SOC FPGA integrates processor and FPGA architecture. An SOC FPGA is a device that comprises a System-on-a-Chip and programmable logic on the same device. The SOC FPGA is logically divided into a processing system (PS) and programmable logic (PL).

The processing system forms the System-on-a-Chip (SoC), and comprises a processor 802 and external memory controller 805. Processor 802 is optionally an application processor unit. In one example the processing unit 802 is an ARM® Cortex-A9 Based processor. The processor 802 may be coupled to on-chip Read Only Memory (ROM—not shown) (non-volatile storage), and on-chip Random Access Memory (RAM) (not shown). The processor 802 is also coupled to external memory controller 805 configured to communicate with off-chip memory, such as HSM non-volatile storage and RAM as will be described in relation to FIG. 7 below. Further components may be included in the SOC FPGA. For example, it may further comprise a battery backed RAM component (BBRAM). It may further comprise a built in hardware AES engine.

The processing system 600 is configured to execute program instructions retrieved from memory, for example boot instructions retrieved from on-chip ROM and application program instructions retrieved from the external non-volatile memory, for example HSM non-volatile memory.

The process of configuring the programmable logic to implement the desired logic functions is referred to as the FPGA design flow. A first step of the FPGA design flow is design entry. In this step a user generates a description of the hardware circuit that the FPGA is to implement. The description may take the form of a schematic. Alternatively, and more likely for complicated designs, the hardware circuit may be described using a Hardware Description Language (HDL) such as VHDL (Very high speed integrated circuit Hardware Description Language).

A second step of the FPGA design flow is synthesis. During synthesis the high-level hardware description of the circuit, which may be in the form of a Hardware Description Language, is converted to a hardware architecture (i.e. a gate-level circuit) that uses the primitives of the specific FPGA, i.e. the smallest atomic logic elements of the FPGA like flip-flops, multiplexers, block RAM etc. The output of synthesis is a netlist, also referred to as an un-routed netlist or a post-synthesis netlist, comprising an indication of the FPGA elements used to implement the hardware circuit and an indication of the interconnections between these elements.

A third step of the FPGA design flow is place and route. During place and route, the netlist (generated in step 2) is analysed and mapped to a specific physical hardware resource in the FPGA (place), the elements are then interconnected (route) to form the functionality of the hardware circuit (specified in step 1). The place and route step can be subject to a number of constraints. For example, a user can specify timing constraints to ensure logic elements will comply with timing requirements, for example a synchronous circuit being able to process data accurately at a specified clock rate.

Alternately or additionally, the location of design elements can be constrained to specific areas of the FPGA die, known as Absolute LOC (Location) constraints.

The output of place and route is a FPGA bitstream, also referred to as a bit file. The FPGA bit stream comprises programming information that is used by the FPGA to implement the hardware circuit, i.e. implementing the functionality specified in step 1, using physical FPGA resources, according to the user constraints regarding timing/placement etc. of step 3.

The FPGA bit file is then loaded in to non-volatile memory 208 of the HSM described below for example, and the FPGA is configured to read the bit file from the non-volatile memory during power up and implement the functionality of the bit file. In one example a bit file is loaded onto the FPGA using a JTAG programmer (named after the Joint Test Action Group).

The FPGA implements a serial transceiver. The serial transceiver is implemented as a “hard IP block”, with limited reprogrammability. The serial transceiver is configured to transmit the first voltage signal and second voltage signal along the first electrically conductive element 106a and the second electrically conductive element 106b. The serial transceiver is further configured to receive the transmitted signal and perform analysis to generate one or more eye pattern parameter values, as has been described previously. The tamper detection module 110 is implemented as software in the processing system of the SoC FPGA.

In the above described example, signal integrity is measured by providing a high frequency signal and measuring one or more eye pattern parameters.

However, in other examples, signal integrity may be measured by providing a signal with a fast rise time, and making a time domain reflectometry (TDR) measurement.

As has been described previously, reflections can have a detrimental impact on the integrity of a signal. Reflections may be caused by impedance discontinuities in the signal path—in this case the electrically conductive elements. A change in the integrity of the signal may therefore be measured using time domain reflectometry (TDR). TDR can be used to detect impedance discontinuities in an electrically conductive element, where such discontinuities result in reflections of the signal. A new detected reflection, which was not present in previous measurements, may therefore indicate the introduction of one or more impedance discontinuities to the electrically conductive element, which may correspond to a tamper event. A tamper event may therefore be registered responsive to detecting a change between a reflectometry measurement for a transmitted first signal edge and a reflectometry measurement for a transmitted second signal edge, sent after the first signal edge. Detecting a change between the measurement for the first signal edge and the measurement for the second signal edge may comprise detecting an additional reflection in the reflectometry measurement.

A TDR measurement may be performed using the device 100 illustrated in FIG. 1 for example. For example, transmitting the signal through the electrically conductive element may comprise transmitting a first signal edge at the first time, and obtaining the first measurement of the integrity may comprise performing a first time domain reflectometry measurement. Transmitting the signal further comprises transmitting a second signal edge at the second time, and obtaining the second measurement of the integrity comprises performing a second time domain reflectometry measurement Detecting a difference between the first measurement and the second measurement may indicate a tamper event.

The signal edge may be a rising edge and/or a falling edge. The signal edge may be a step signal, and/or a signal pulse. The signal edge is preferably fast. For example, a signal edge rise time may be less than 1 ns. In some examples, the signal edge rise time is as short as about 10 ps.

FIG. 6 illustrates another method 600 according to an example using TDR. The method 600 may be performed by the device 100 illustrated in FIG. 1(a). In one example, only a single electrically conductive element 106a may be used, instead of a differential pair.

At step S602 of the method 600, a signal is transmitted through the first electrically conductive element 106a. The signal may comprise a rising edge and/or a falling edge. The signal may comprise a step signal, and/or a signal pulse. The signal edge is preferably fast. For example, a signal edge rise time may be less than 1 ns. In some examples, the signal edge rise time is as short as about 10 ps.

At step S604 of the method 800, a time domain reflectometry measurement for the signal is obtained.

At S606, responsive to detection of a reflection, a tamper event is registered.

In this example, time-domain anti-tamper detection is performed. A signal having a fast rise time is used. Fast rise-times result enable more accurate reflections from any impedance discontinuities to be detected. The time domain reflectometry may be performed using a SoC FPGA as has been described previously. For example, the method may comprise oversampling a 1-5 GHz test signal at 20-30 GHz. A pseudo random binary signal may be sent. For example, if a 00000000001111111111 pattern is sent and a 00000000001010111111 pattern received, this characterises the time-domain reflections.

In this example, the transmitter 102 sends a fast rise time signal to the receiver 104. A measurement is then performed at both the transmitter 102 and receiver 104. Under normal conditions, no signal should be detected at the transmitter 102. Any signal detected at the transmitter is therefore an indication of an impedance discontinuity, and is registered as a tamper event.

Optionally, a measurement is also made at the receiver. Under normal conditions, the receiver 104 should detect only the first signal edge. If there are subsequent reflections, this indicates impedance discontinuities.

As has been described previously, the tamper detection may be performed repeatedly, where each signal edge is transmitted to characterise the tamper detection line. Subsequent signal edges are sent to confirm that the line has not changed.

In other examples, a change in the integrity of the signal may also be detected as a change in the characteristic scattering parameters (S-parameters) measured for an electrically conductive element. Such a method may be performed using the device 100 described in relation to FIG. 1(a) for example.

In particular, transmitting the signal through the electrically conductive element may comprise transmitting a first signal at the first time, and obtaining the first measurement of the integrity may comprise measuring a first set of S-parameters. Transmitting the signal further comprises transmitting a second signal at the second time, and obtaining the second measurement of the integrity comprises measuring a second set of S-parameters Detecting a difference between the first measurement and the second measurement may indicate a tamper event.

For example, the electrically conductive element can be considered as a network having a number of signal inputs/outputs referred to as ports (e.g. two, three, or four ports), and may have an associated set of characteristic S-parameters determined over a scanned range of frequencies transmitted through the electrically conductive element. A change in the measured S-parameters may indicate a change in the gain/loss of the electrically conductive element, and/or the reflected power at one or more of the ports, and may therefore indicate that tampering has occurred.

The first and/or second signals transmitted through the electrically conductive element may comprise a scan over a range of frequencies.

Measuring the S-parameters is another example of frequency-related anti-tamper detection.

In the above described examples, the processing module 105 is implemented using a field-programmable gate array (FPGA), for example a SoC FPGA. In other examples, the processing module 105 may be implemented using an application specific integrated circuit (ASIC), or one or more central processing units (CPUs).

The device 100 may store or process sensitive data. Various devices may be designed to store and perform operations with sensitive data. For example, a Hardware Security Module (HSM) is a device that securely stores and manages cryptographic keys, and performs a set of cryptographic operations, such as generating a cryptographic key, performing encryption and decryption or performing digital signature and verification operations. The device 100 shown in FIG. 1(a) may be implemented as a HSM device.

FIG. 7 is a schematic illustration showing a plan view of an example HSM device 100. The HSM comprises a plurality of hardware components mounted on a first surface of a PCB 101, including a processing module 105 such as has been described in relation to FIG. 1(a) above. The device 100 further comprises a first electrically conductive element 106a and a second electrically conductive element 106b, such as has been described in relation to FIG. 1(a) above. The PCB 101 in this example is a multi-layer PCB 101.

The device 100 further comprises an Input/Output (IO) connector 110. The IO connector 110 is communicatively coupled to the processing module 105 and is configured to act as an interface, through which data is communicated, between the processing module 105 and an external system. The Hardware Security Module (HSM) device 100 in this example is configured to be communicatively coupled to a computer or server device in an external system through the Input/Output (10) connector 110. For example, the Hardware Security Module (HSM) device 100 can be a PCI express card, which can be directly plugged into the computer or server device. In this case the Input/Output (10) connector is a PCIe connector. In use, the Hardware Security Module (HSM) device 100 receives user requests through the Input-Output (10) connector 100 The requests may comprise commands to perform certain cryptographic operations.

The Input-Output (10) connector 100 is communicatively coupled to the processing module 105 by an electrically conductive connection, which may comprise a trace on the PCB 200.

The Hardware Security Module (HSM) further comprises non-volatile memory 107 and working memory comprising Random Access Memory (RAM) 108. The non-volatile memory 107 may include any form of non-volatile device memory. In an example, the non-volatile memory 208 includes Flash memory and Electrically Erasable Read Only Memory (EEROM). The RAM 108 may be DDR RAM. The processing module 105 is in wired bi-directional communication with both the non-volatile storage 107 and the Random Access Memory (RAM) 108. The working memory of the device comprises the RAM 108 and working memory provided in the processing module 105.

The HSM device 100 further comprises a random number generator component 111.

The HSM device 100 may comprise additional components which are not shown in the figure, for example a power reset component configured to control the power provided to the processing module 105. A user can control power to the processing module 105 via the Input/Output connector 110.

A user may store sensitive cryptographic material on the HSM. For example, one or more cryptographic application keys are associated with a user of the HSM device. The cryptographic application keys may be securely stored on the HSM. Alternatively, the cryptographic application keys may be encrypted with a master key and stored outside the HSM. The master key, or material that can be used to obtain the master key, is then securely stored inside the HSM.

Computer program code is stored in the HSM non-volatile memory 107. When executed, a program is represented as a software product, or process, in the working memory. The processor system in the processing module 105 comprises logic circuitry that responds to and processes instructions in program code present in the working memory. A main application program may implement cryptographic functionality and tamper detection functionality as described above. The main application program is program code comprising a set of computer instructions. The main application program comprises machine code stored in the non-volatile memory 107 on the HSM. Also stored in the non-volatile memory 107 on the HSM are any components necessary to execute the main application program, including runtime system files. When executed, a copy of the main application program machine code is loaded in the working memory.

The main application program may comprise computer instructions embodying a set of one or more cryptographic algorithms. For example, the main application program comprises computer instructions embodying one or more of the following cryptographic algorithms: cryptographic key generation; key derivation: encryption: decryption; and digital signature algorithms (for example digital signing or validation of a digital signature). The main application program may further comprise computer instructions embodying the tamper detection functionality described in relation to the tamper detection module 110 above.

The main application program can be embedded in the non-volatile memory 108 of the Hardware Security Module when the Hardware Security Module (HSM) is manufactured by a trusted party, or can be provided by the trusted party as a whole or in part after manufacture. For instance, the main application program can be introduced by the trusted party as a computer program product, which may be in the form of a download. Alternatively, modifications to an existing main application program can be made by the trusted party by an update or plug-in. Execution of the main application program by the processor 105 causes various functionality of a Hardware Security Module (HSM), such as generating cryptographic keys, storing cryptographic keys, or performing cryptographic operations etc., to be implemented.

The processing unit 802 in the SoC FPGA 105 runs an operating system, for example a Linux operating system. The operating system comprises system software that manages the hardware and software resources of the HSM device, and acts as an intermediary between the main application program and the HSM hardware.

The processing unit 802 is configured to communicate with programmable logic via an interconnect, for example a bus. In one example, the interconnect is an ARM AMBAO® AXI based interface. In this way, the software being executed by the processing unit 802 can interact with the programmable logic, for example to obtain a value calculated by the programmable logic, start a hardware operation etc.

A bit file for the programmable logic, including instructions on how to configure the programmable logic to perform the desired functionality, can be stored in the non-volatile memory 107 of the HSM. The SOC FPGA 105 may be configured to perform, using the configurable logic, various cryptographic functions in hardware, for example various standard encryption and decryption algorithms, and digital signature algorithms. For example, the SOC FPGA 105 is configured to provide at least one of: a public key hardware accelerator (PKSA), a random number generator, an advanced encryption standard accelerator (AESA) and a message digest hardware accelerator (MDHA). In the SOC FPGA 105, one or more of these operations are implemented directly in hardware.

The programmable logic is configured to receive requests to perform one or more of these operations from the processing unit 802 and to return to the processing unit 802 the output of the operation. The processing unit 802 is configured to off-load various operations to the programmable logic. The programmable logic is configured to perform certain operations in hardware, meaning that these operations may be performed more efficiently on the programmable logic than in the processing unit 802.

The processing unit 802 of the FPGA 105 is configured to execute the main application program.

The PCB 101 in this example is a multi-layer PCB 101. The PCB 101 comprises one or more ground layers. The processing module 105, non-volatile memory 107 and RAM 108 are mounted on a first surface of the PCB 101. A first connection 201 is provided between the processing module 105 and the non-volatile memory 107. Sensitive data may be transmitted through the first connection 201. The first connection 201 is provided on a first internal layer of the PCB 101, in particular, the first connection 201 comprises a trace on a first internal layer of the PCB 101. Furthermore, the first connection 201 is connected to the processing module 105 at a location between the processing module 105 and the PCB 101. The first connection 201 is connected to the non-volatile memory 107 at a location between the non-volatile memory 107 and the PCB 101. A second connection 200 is provided between the processing module 105 and the RAM 108. Sensitive data may be transmitted through the second connection 200. The second connection 200 is provided on a first internal layer of the PCB 101. In particular, the second connection 200 comprises a trace on a first internal layer of the PCB 101. Furthermore, the second connection 200 is connected to the processing module 105 at a location between the processing module 105 and the PCB 101. The second connection 200 is connected to the RAM 108 at a location between the RAM 108 and the PCB 101.

The first electrically conductive element 106a and the second electrically conductive element 106b are provided on a second internal layer of the PCB 101. The first electrically conductive element 106a and the second electrically conductive element 106b are provided in a serpentine pattern across an area that overlaps with the location of at least part of the first connection 201 and the second connection 200, and the non-volatile memory 107 and the RAM 108. Furthermore, the first electrically conductive element 106a and the second electrically conductive element 106b are connected to the processing module 105 at locations between the processing module 105 and the PCB 101. The second internal layer is provided between the surface of the PCB 101 on which the processing module 105 is mounted, and the first internal layer. In this way, an attacker attempting to access the first connection 201 or second connection 200 from the surface of the PCB 101 on which the processing module 105 is mounted would interfere with the first electrically conductive element 106a and the second electrically conductive element 106b.

As described previously, the first electrically conductive element 106a and the second electrically conductive element 106b each use a constant characteristic impedance suitable for carrying high speed signals. The transmitter 102 is configured to transmit a signal through each of the first electrically conductive element 106a and the second electrically conductive element 106b to the receiver 104, at which a measurement of the integrity of the signal is made. The return path from the receiver 104 to the transmitter 102 is provided at least partly through a ground layer in the PCB 101, where the processing module 105 is coupled at multiple locations to the ground layer. Tamper attempts change this at some point along the trace or return path, which can be detected as a change in the received eye pattern for example. The return path may mirror the signal path on the ground layer. Modifications to the ground layer may therefore also be detected. The method can detect modifications to the trace itself, as well as modifications that affect the ground return path. It can also detect changes to the PCB in close proximity to the trace or return path. The method can detect touch, modification, scraping, substrate compression/heating and even nearby drilling.

Although in the above described example, a single differential pair is arranged in a wire labyrinth to protect one or more components, and one or more connections to components, in other examples, multiple sets of anti-tamper traces can be used in a single device to detect tampering on individual PCB layers for example.

The multiple sets of anti-tamper traces may be provided on different layers of the PCB. The multiple sets of anti-tamper traces may be provided to protect different connections or components and may be provided in different regions of the PCB. The multiple sets of anti-tamper traces may be provided in the same or an overlapping region of the PCB, with the traces offset or provided at a greater than zero angle to each other, in order to more fully cover the region of the PCB.

For example, a signal comprising sensitive data, such as a signal between the FPGA 105 and the non-volatile memory 107, may be transmitted via a trace on an inner layer of the PCB 101. The inner layer may be sandwiched between a first PCB layer having one or more electrically conductive elements 106 used to detect a tamper attempt disposed thereon and a second PCB layer having one or more electrically conductive elements 106 used to detect a tamper attempt disposed thereo.

FIG. 8 schematically illustrates another HSM device 100. The HSM device 100 is similar to the HSM device 100 illustrated in FIG. 7, Description of features in common with FIG. 7 will not be repeated. The same reference numerals are used for the same components.

In the HSM device 100 shown in FIG. 8, unlike the HSM device 100 shown in FIG. 7, the first electrically conductive element 106a and the second electrically conductive element 106b are provided in a serpentine pattern across an area that overlaps with the location of the first connection 201 and the second connection 200, but do not overlap with the non-volatile memory 107 and the RAM 108.

The HSM device 100 further comprises a third electrically conductive element 106X and a fourth electrically conductive element 106Y, which are provided on a third internal layer of the PCB 101. The third electrically conductive element 106X and the fourth electrically conductive element 106Y are provided in a serpentine pattern across an area that overlaps with the location of at least part of the first connection 201 and the second connection 200, and that overlaps with the location of at least part of the first electrically conductive element 106a and the second electrically conductive element 106b. Furthermore, the third electrically conductive element 106X and the fourth electrically conductive element 106Y are connected to the processing module 105 at locations between the processing module 105 and the PCB 101. The third internal layer is provided between the surface of the PCB 101 opposite to the surface on which the processing module 105 is mounted, and the first internal layer. In this way, the first internal layer is sandwiched between the second internal layer and the third internal layer. In this way, an attacker attempting to access the first connection 201 or second connection 200 from the surface of the PCB 101 on which the processing module 105 is mounted or the opposite surface of the PCB 101 would interfere with the first electrically conductive element 108a and the second electrically conductive element 106b or the third electrically conductive element 106X and the fourth electrically conductive element 106Y.

The serpentine pattern of the third electrically conductive element 106X and the fourth electrically conductive element 106Y is provided perpendicular to the serpentine pattern of the first electrically conductive element 106a and the second electrically conductive element 106b, so that the serpentine patterns cross each other. For example, the serpentine pattern of the third electrically conductive element 106X and the fourth electrically conductive element 106Y is provided with the elongated sections running from a first edge of the PCB 101a to a second edge of the PCB 101b which is opposite to the first edge. For example, the serpentine pattern of the first electrically conductive element 106a and the second electrically conductive element 106b is provided with the elongated sections running from a third edge of the PCB 101c to a fourth edge of the PCB 101d which is opposite to the third edge. The first 101a and second 101b edges are parallel to each other. The third 101c and fourth 101d edges are parallel to each other and perpendicular to the first 101a and second 101b edges.

The HSM device illustrated in FIG. 8 comprises two sets of traces used for tamper detection, wherein connections between the non-volatile memory 107 and the processing module 105, and between the RAM 108 and the processing module 105, are sandwiched between the sets of traces used for tamper detection. It will be appreciated that both sets of traces used for tamper detection are connected to the processing unit 105 (e.g. to a serial transceiver 103 as illustrated in FIG. 1(a)). By configuring the processing module 105 to monitor the integrity of signals transmitted by both sets of traces used for tamper detection, using one or more of the methods described herein, an attempt to tamper with the connections between the processing module 105 and the non-volatile memory 107, and/or the RAM 108 (e.g. by drilling through the layers of the PCB 101), causes a detectable change in the integrity of the signal transmitted by one or both of the sets of traces used for tamper detection, and therefore a tamper event to be registered.

FIG. 9 is a flow chart of a method of manufacturing a device according to an embodiment. The method may be used to manufacture the device of FIG. 1(a) for example. Step S1102 comprises manufacturing a circuit board comprising an electrically conductive element. An initial step of designing the PCB may be performed, in which the electrically conductive element is specified. The PCB is then manufactured with the specified element. The PCB may be manufactured with a differential pair, as described in relation to FIG. 1(a) for example. Step S1104 comprises mounting a processing module 105 coupled to the electrically conductive element. The processing module 105 may be a SoC FPGA, as described in relation to FIG. 1(a) for example.

The processing module may be mounted onto the PCB 101 using solder joints. Step S1106 comprises mounting one or more components onto the PCB 101.

The above described methods use high speed signals, and monitor for fundamental effects in the detection process, and thus may make the challenge of defeating the tamper detection mechanism harder. This may provide increased security and reduced manufacturing cost as compared to methods using either static or low speed testing of the tamper boundary, which may be easier to defeat.

While certain embodiments have been described, these embodiments have been presented by way of example only, and are not intended to limit the scope of the inventions. Indeed the novel methods and devices described herein may be embodied in a variety of other forms; furthermore: various omissions, substitutions and changes in the form of methods and apparatus described herein may be made without departing from the spirit of the inventions. The accompanying claims and their equivalents are intended to cover such forms of modifications as would fall within the scope and spirit of the inventions.

1. A device comprising:
an electrically conductive element;
a processing module, configured to:
transmit a signal through the electrically conductive element;
obtain, at a first time, a first measurement of the integrity of the signal transmitted through the electrically conductive element;
obtain, at a second time, a second measurement of the integrity of the signal transmitted through the electrically conductive element; and
responsive to detection of a change in the integrity of the signal between the first and second measurements, register a tamper event.

2. The device according to claim 1, wherein the first measurement of the integrity of the signal and the second measurement of the integrity of the signal comprise one or more eye pattern parameters.

3. The device according to claim 2, wherein the one or more eye pattern parameters comprise a measure of eye height and a measure of eye width.

4. The device according to claim 1, wherein the electrically conductive element is provided on or in a first region of a printed circuit board and the device further comprises a first component configured to store or process sensitive data, wherein a connection to the first component is provided on or in the printed circuit board within the first region.

5. The device according to claim 1, wherein transmitting the signal through the electrically conductive element comprises generating a signal comprising a first data sequence, and wherein the processing module is further configured to:
compare, at the second time, the signal transmitted through the electrically conductive element to the first data sequence;
responsive to detecting a difference in the sequence of data, register a tamper event.

6. The device according to claim 1, wherein registering a tamper event comprises outputting a notification that a tamper event has taken place and/or erasing sensitive data from the device.

7. The device according to claim 1, wherein transmitting the signal through the electrically conductive element comprises generating a pseudo random binary sequence.

8. A device according to claim 1, wherein transmitting the signal comprises generating a signal with a frequency corresponding to a first integrity of the signal transmitted through the electrically conductive element, wherein the first integrity is less than or equal to 0.75 times a maximum integrity of a signal transmitted through the electrically conductive element.

9. A device according to claim 1, wherein transmitting the signal comprises generating a signal with a frequency corresponding to a first loss of the signal transmitted through the electrically conductive element, wherein the first loss is greater than or equal to 25%.

10. A device according to claim 1, wherein the frequency of the signal is greater than or equal to 1 GHz.

11. A device according to claim 1, wherein the electrically conductive element is a first electrically conductive element and wherein the device further comprises a second electrically conductive element, wherein the first electrically conductive element and the second electrically conductive element form a differential pair.

12. A device according to claim 1, wherein the signal comprises a first level and a second level, wherein:
obtaining the first measurement of the integrity of the signal comprises obtaining a first plurality of samples of transitions between the first level and second level; and
obtaining the second measurement of the integrity of the signal comprises obtaining a second plurality of samples of transitions between the first level and second level.

13. A device according to claim 12, wherein obtaining the first measurement of the integrity of the signal further comprises determining a first edge of the first plurality of samples of transitions between the first level and second level, and wherein obtaining the second measurement of the integrity of the signal comprises determining a second edge of the second plurality of samples of transitions between the first level and second level.

14. A device according to claim 1, wherein the signal is a first signal and wherein the first signal is transmitted for a first time period to obtain the first measurement and wherein the first signal is transmitted for a second time period after the first time period to obtain the second measurement, wherein the processing module is further configured to:
transmit a second signal through the electrically conductive element the second signal having a different frequency to the first signal;
obtain, at a third time, a third measurement of the integrity of the signal transmitted through the electrically conductive element;
obtain, at a fourth time, a fourth measurement of the integrity of the signal transmitted through the electrically conductive element, wherein the second signal is transmitted for a first further time period to obtain the third measurement and wherein the second signal is transmitted for a second further time period after the first further time period to obtain the fourth measurement, wherein the first further time period is after the first time period and before the second time period, and the second further time period is after the second time period; and
responsive to detection of a change in the integrity of the signal between the third and fourth measurements, register a tamper event.

15. A method comprising:
transmitting a signal through an electrically conductive element;
obtaining, at a first time, a first measurement of the integrity of the signal transmitted through the electrically conductive element;
obtaining, at a second time, a second measurement of the integrity of the signal transmitted through the electrically conductive element; and
responsive to detection of a change in the integrity of the signal between the first and second measurements, registering a tamper event.
